(19) United States
(12) Patent Application Publication
(10) Pub. No.: US 2020/0218739 A1
(43) Pub. Date: Jul. 9, 2020

(54) SYSTEM AND PROCESS USING A SEMANTIC DATABASE

(71) Applicants: Toby Unwin, Orlando, OH (US); Marcelo Triana, Norfolk (GB)

(72) Inventors: Toby Unwin, Orlando, OH (US); Marcelo Triana, Norfolk (GB)

(73) Assignee: Prescience AI Limited, Norfolk (GB)

(21) Appl. No.: 16/241,815

(22) Filed: Jan. 7, 2019

(51) Int. Cl. G06F 16/28; G06F 16/22; G06F 17/27; G06F 16/25

(52) U.S. Cl. CPC G06F 16/288; G06F 16/252; G06F 17/2785; G06F 16/2282

(57) ABSTRACT

The current invention is an artificial intelligence system that uses a sematic database with both a CRM system and analytics systems. The systems will define a data dictionary, define data sources (crawlers and APIs), configure analytics modules & settings, and set automation workflows. This allows dozens of tables can be reduced to just 5 table for 1. Contacts, 2. Companies, 3. Opportunities, 4. Activities and 5. Items.

### CROSS-REFERENCES TO RELATED APPLICATIONS (IF ANY)

None

### BACKGROUND OF INVENTION

### Field of the Invention

The present invention is directed to a method of using a sematic database for analytical and customer relationship management systems.

### Background

The definition of CRM is customer relationship management. CRM lets you store and manage prospect and customer information, like contact info, accounts, leads, and sales opportunities, in one central location.

Analytics systems are systems used to analyze data such a court filings, judges, courts, attorneys and law suit results.

Analytic solutions systems are very powerful, but very, very niche. There are dozens of tables. A new industry involves creating dozens more tables. Copies of the existing analytics reports will be needed to read the new tables, increasing development and maintenance costs. Analytics and the new CRM systems don't share tables, so don't work together.

There is still room for improvement in the art.

### SUMMARY OF THE INVENTION

The current invention is an artificial intelligence system that uses a sematic database with both a CRM system and analytics systems. The systems will define a data dictionary, define data sources (crawlers and APIs), configure analytics modules & settings, and set automation workflows.

### BRIEF DESCRIPTION OF THE DRAWINGS

Without restricting the full scope of this invention, the preferred form of this invention is illustrated in the following drawings:

FIG. 1 is a block diagram showing a basic arrangement of a computer system that can run the current invention; and

FIG. 2 is a schematic block diagram of a conceptualized operation of the present invention; and

FIG. 3 shows a semantic database display.

### BRIEF DESCRIPTION OF THE PREFERRED EMBODIMENTS

There are a number of significant design features and improvements incorporated within the invention.

The current invention is a system 1, method and program product that uses an analytic and customer relationship management system with a semantic database to analyze litigation results and risks of court cases using real time data.

The system 1, uses an artificial intelligence system that takes litigation results by area and line of business and compiles the results using a semantic database.

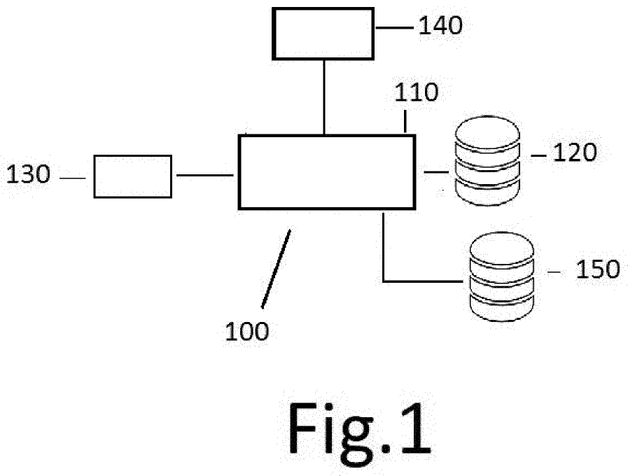

The system 1 can be set up to be run a on a computing device. FIG. 1 is a block diagram showing a computing device 100 on which the present invention can run comprising a CPU 110, Hard Disk Drive 120, Keyboard 130, Monitor 140, CPU Main Memory 150 and a portion of main memory where the program resides and executes. A printer can also be included. Any general purpose computer with an appropriate amount of storage space is suitable for this purpose. Computer Devices like this are well known in the art and is not pertinent to the invention.

The computer device 100 could be connected to other computer devices 100 through a communication interface such as the Internet, a wide area network (WAN), internetwork, telephone network or a private Value Added Network (VAN).

The storage and databases for the system may be implemented by a single data base structure at an appropriate site, or by a distributed data base structure that is distributed across an intra or an Internet network.

The files and file components discussed herein may be paper files, but in a preferred embodiment comprise data structures with electronic data. The setting up of the files and file structure is commonly known in the art and is not disclosed here. The system 1, data, files and processing code can reside in the non-transitory memory of the one or more computing devices.

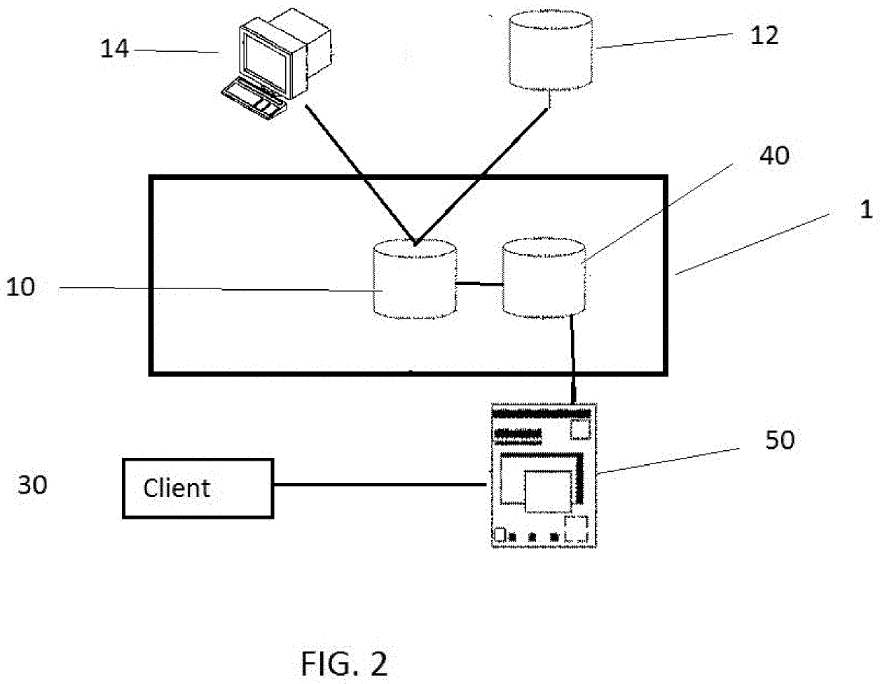

This system 1 is shown in FIG. 2, the System 1 will gather information 10 about court case results.

The information 10 about the results and findings can be gathered from databases 12 or keyed into the system 1 by a keyboard entry 14 or any other method of entry. The information 10 will have data on everything relevant available that can be used to analysis the litigation results. This data would include but not limited to the location, results of the suit or the settlement received and the amount.

This data 40 can be specifically compiled and analyzed using a computer processing means.

The data 40 is loaded into electronic medium and is analyzed by the system 1 based on the desired criteria.

The system 1 uses a semantic database that is updated in real time such as hourly. It re-configure the tables so the analytics system 1 and a CRM system can use the same tables. This allows dozens of tables can be reduced to just five tables. The tables, in the preferred embodiment are: 1. Contacts, 2. Companies, 3. Opportunities, 4. Activities and 5. Items.

These tables will need 3 additional fields added to them. These fields are Record Owner, Relationships (with other records), and Descriptor(s).

Contacts for the analytics system can be judges, Lawyers, Clients, etc. A Judges table can be replaced by a Judges Category, e.g. Contacts/Judges. The same for Contacts/Lawyers, Contacts/Clients, etc. This makes it so that there is no need for new tables, just make new categories.

Companies can be Law Firms, Chambers, etc. Companies/Law Firms, Companies/Chambers,etc. Companies/Hospitals, Companies/Clinics could easily be future categories.

Opportunities can store Cases as a category, or claims. Moving a claim to a case simply involves changing its category while the data stays in the same place.

Activities are history tables, like customer interactions, lawsuit dockets and court calendars. Items can be tangible, like property, or intangible, like a lien.

Adding items is a significant leap over CRMs. A CRM cannot handle inventory, accounting, etc because it lacks a table to store the data.

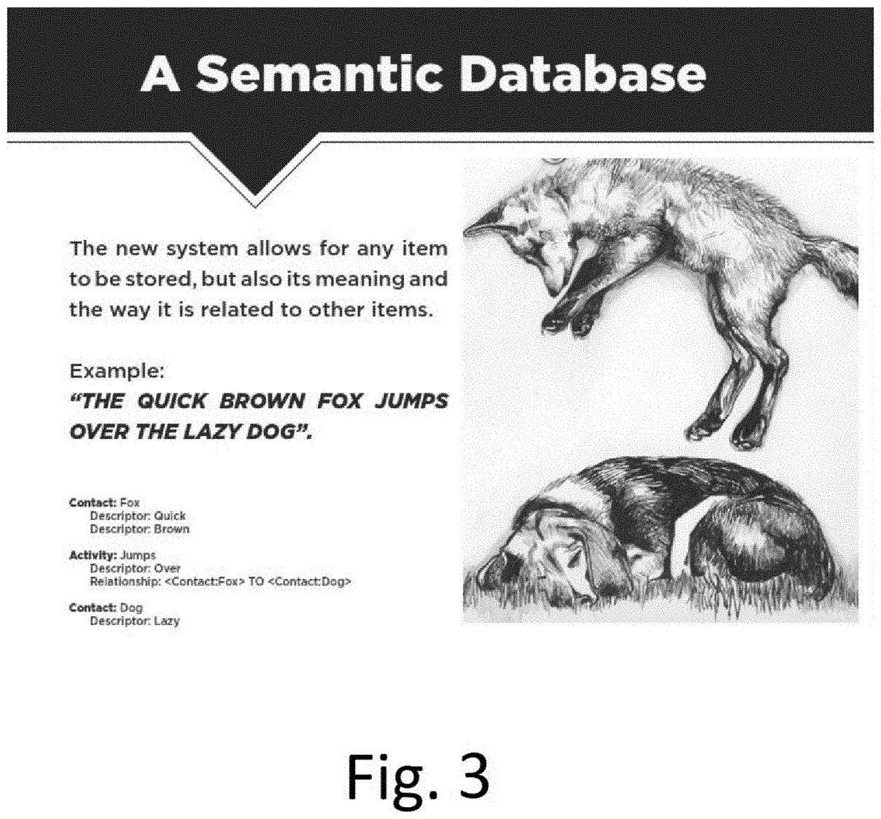

As shown in FIG. 3, the system allows for any item to be stored, but also its meaning and the way it is related to other items.

### EXAMPLE

“THE QUICK BROWN FOX JUMPS OVER THE LAZY DOG”.

Contact: Fox Descriptor: Quick Descriptor: Brown

Activity: Jumps

Descriptor: Over

Relationship: <Contact:Fox>TO <Contact:Dog>

Contact: Dog

Descriptor: Lazy

Sources like raw text, newspapers, telephone transcript scan be mapped as the structure of language. Nouns, verbs, adjectives etc. lend themselves to categorization. Any language sentence can be mapped. So any language query can be retrieved and analyzed.

For Example,

Find:Twitter users, praising ISIS, living in Walthamstow

UK, owning a grey hoodie with a purple logo.

How likely is it that John knows Kathleen?

No new tables.

Integration with CRM/ERP data.

The analytics system 1 no longer measures lawyers, law firms and cases. It now measures Contacts, Companies and Opportunities. These can easily be Contacts/Doctors, Companies/Hospitals and Opportunities/Medical Cases, etc.

The system 1 will: 1. Define data dictionary, 2. Define data sources (crawlers and APIs), 3. Configure analytics modules & settings, and 4. Set automation workflows.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method comprising the steps: having information, loading this information into a semantic database stored on electric means in non-transitory memory, having the database be used by both an analytical and customer relationship management system, using this information to create data, using the data to product analytical result.

2. The method as defined in claim 1, wherein said database has at least five unique tables.

3. The method as defined in claim 2, where those tables are contacts, companies, opportunities, activities and items.

4. The method as defined in claim 3, where those table have one or more fields from the set of record owner, relationships with other records, and descriptors.

5. The method as defined in claim 3, where the contacts can be one or more from a set of judges, lawyers, and clients.

6. The method as defined in claim 3, where the companies can be one or more from a set of law firms, chambers, clinics and companies.

7. The method as defined in claim 3, where opportunities can be stored cases as a category, or claim.

8. The method as defined in claim 3, where the activities can be one or more from a set of history tables, lawsuit dockets and court calendars.

9. The method as defined in claim 3, where the Items can be tangible or intangible.
